(19) United States
(12) Patent Application Publication
(10) Pub. No.: US 2017/0095044 A1
(43) Pub. Date: Apr. 6, 2017

(54) REPLACEMENT WATCH BAND DEVICE FOR WATCHES

(71) Applicant: Willie Threatt, Mid West City, OK (US)

(72) Inventor: Willie Threatt, Mid West City, OK (US)

(21) Appl. No.: 14/872,213

(22) Filed: Oct. 1, 2015

(51) Int. Cl. A44C 5/14; G04B 37/14

(52) U.S. Cl. CPC A44C 5/14; G04B 37/1486; A44C 5/145

(57) ABSTRACT

A replacement watch band device for watches for replacing the original band of a watch includes a strip that is flexible and which has a top face, a bottom face, a first end, and a second end. The strip has a first coupler positioned on the bottom face proximate to the first end, and a second coupler, complimentary to the first coupler, positioned on the top face proximate to the second end. The strip also has a first connector positioned on the top face and there is a second connector, complimentary to the first connector, which is positioned on the back side of the watch.

### BACKGROUND OF THE DISCLOSURE

### Field of the Disclosure

The disclosure relates to watch band devices and more particularly pertains to a new watch band device for replacing the original band of a watch.

### SUMMARY OF THE DISCLOSURE

An embodiment of the disclosure meets the needs presented above by generally comprising a strip that is flexible and which has a top face, a bottom face, a first end, and a second end. The strip has a first coupler positioned on the bottom face proximate to the first end, and a second coupler, complimentary to the first coupler, positioned on the top face proximate to the second end. The strip also has a first connector positioned on the top face and there is a second connector, complimentary to the first connector, which is positioned on the back side of the watch.

The strip also may be a first strip and a second strip. The first strip and the second strip each have a top surface, a bottom surface, a proximate end, and a distal end. There is a first fastener positioned on the bottom surface proximate to the proximate end of the first strip, and a second fastener, complimentary to the first fastener, which is positioned on the top surface proximate to the proximate end of the second strip.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top view of a replacement watch band device for watches according to an embodiment of the disclosure.

FIG. 2 is a bottom view of an embodiment of the disclosure.

FIG. 3 is a detailed view of an embodiment of the disclosure.

FIG. 4 is a top perspective view of an embodiment of the disclosure.

FIG. 5 is an operational view of an embodiment of the disclosure.

FIG. 6 is a top view of an embodiment of the disclosure.

### DESCRIPTION OF THE PREFERRED EMBODIMENT

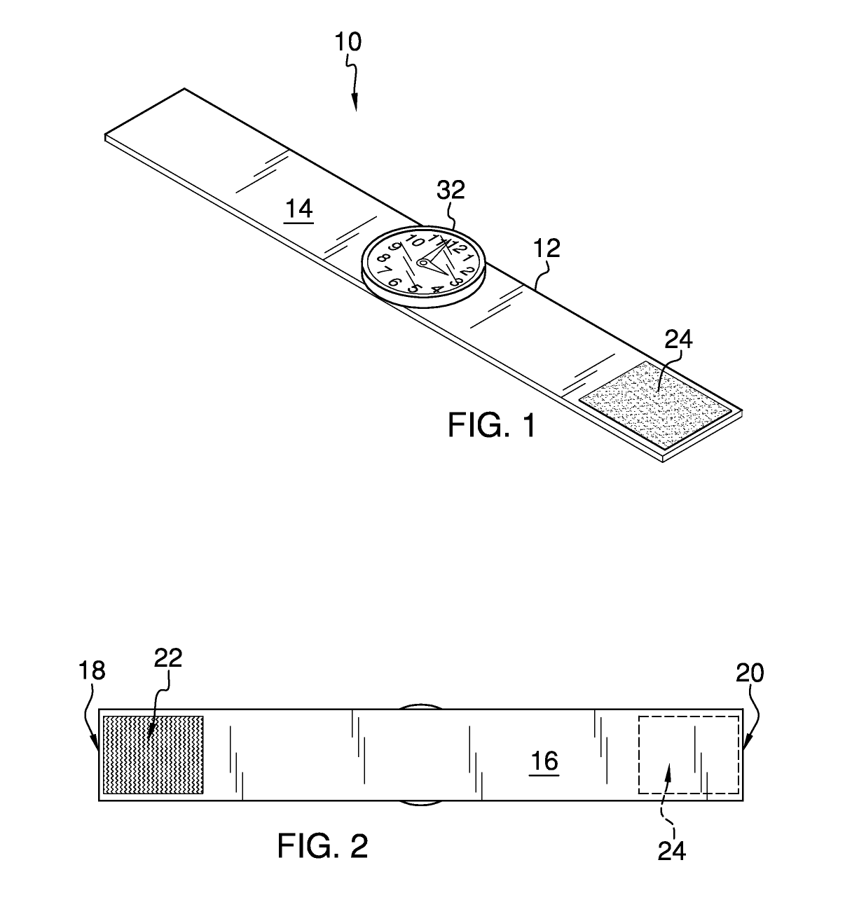

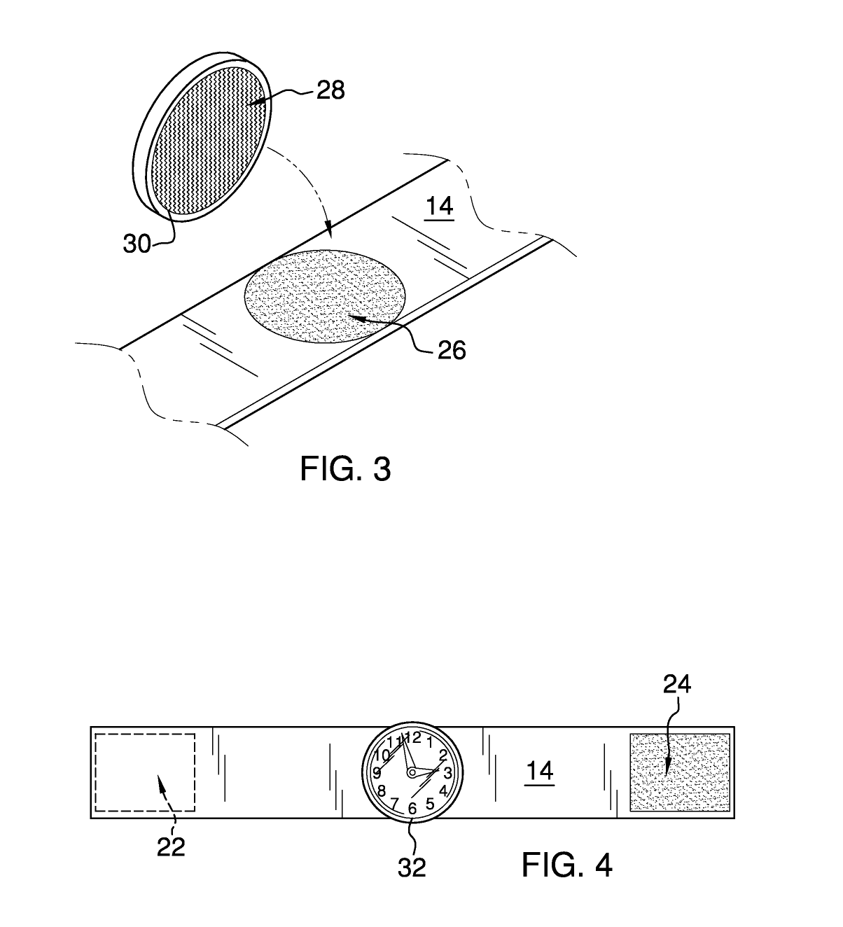

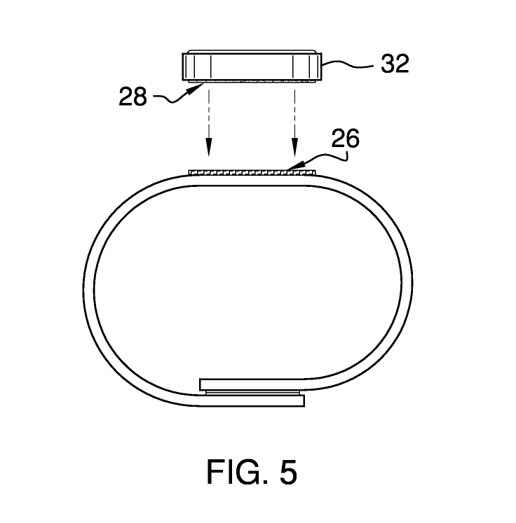

With reference now to the drawings, and in particular to FIGS. 1 through 6 thereof, a new watch band device embodying the principles and concepts of an embodiment of the disclosure and generally designated by the reference numeral 10 will be described.

As best illustrated in FIGS. 1 through 6, the replacement watch band device for watches 10 generally comprises a strip 12 that is flexible. The strip has a top face 14, a bottom face 16, a first end 18, and a second end 20. There is a first coupler 22 positioned on the bottom face 16 proximate to the first end 18, and a second coupler 24, which is complimentary to the first coupler 22, positioned on the top face 14 proximate to the second end 20. The strip 12 has a first connector 26 positioned on the top face 14 equally distant from the first end 18 and the second end 20. A second connector 28, complimentary to the first connector 26, is positioned on the back side 30 of the watch 32. The first coupler 22, the second coupler 24, the first connector 26 and the second connector 28 comprise complimentary pairings of Velcro type hook panels and Velcro type loop panels. The strip may be formed from cloth, rubber, metal or plastic.

In use, the second connector 28 engages the first connector 26 to bond the watch 32 to the strip 12, and the first coupler 22 engages the second coupler 24 to form a loop around the wrist of the watch wearer.

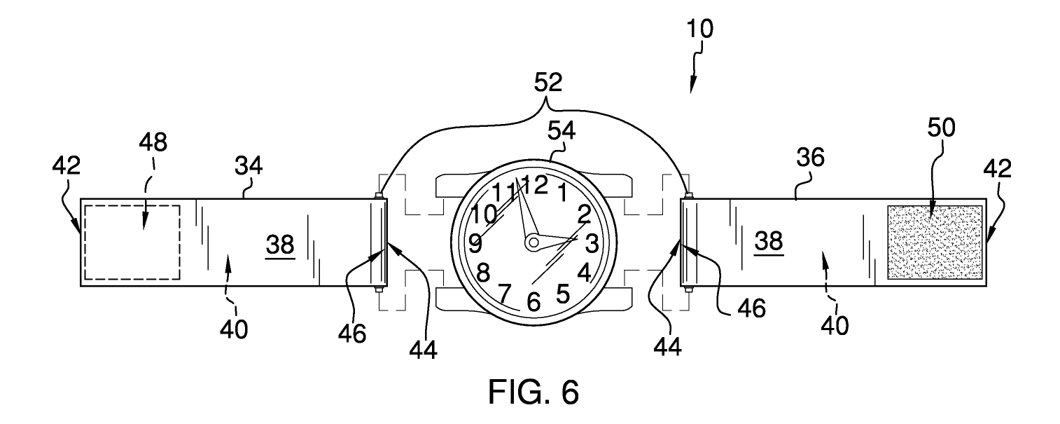

As illustrated in FIGS. 6, the replacement watch band device for watches 10 also generally comprises a first strip 34 and a second strip 36 that are flexible. The first strip 34 and the second strip 36 each have a top surface 38, a bottom surface 40, a proximate end 42, and a distal end 44 shaped as a tube 46. There is a first fastener 48 positioned on the bottom surface 40 proximate to the proximate end 42 of the first strip 34, and a second fastener 50, complimentary to the first fastener 48, which is positioned on the top surface 38 proximate to the proximate end 42 of the second strip 36. The first fastener 48 and the second fastener 50 connector comprise a complimentary pairing of a Velcro type hook panel and a Velcro type loop panel. The first strip 34 and the second strip 36 may be formed from cloth, rubber, metal or plastic.

In use, the tubes 46 on the distal ends 44 of the first strip 34 and the second strip 36 accept the pins 52 of a lug-type watch 54 to secure the first strip 34 and the second strip 36 to the lug-type watch 54. The first fastener 48 is configured to engage the second fastener 50 such that the first strip 34, the second strip 36, and the lug-type watch 54 form a loop around the wrist of the watch wearer.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A replacement watch band device for watches, said device comprising:
a strip, said strip being flexible, said strip having a top face, a bottom face, a first end, and a second end,
a first coupler, said first coupler being positioned on said bottom face proximate to said first end,
a second coupler, said second coupler being complimentary to said first coupler, said second coupler being positioned on said top face proximate to said second end,
a first connector, said first connector being positioned on said top face; and
a second connector, said second connector being complimentary to said first connector, said second connector being positioned on the back side of the watch, wherein said second connector is configured to engage said first connector to bond the watch to said strip, and said first coupler is configured to engage said second coupler with said strip forming a loop around the wrist of the watch wearer.

2. The device of claim 1, further comprising said first coupler, said second coupler, said first connector and said second connector being chosen from the group of materials consisting of Velcro type hook panel and Velcro type loop panel.

3. The device of claim 1, further comprising said strip being formed from the group of materials consisting of cloth, rubber, metal and plastic.

4. The device of claim 1, further comprising said strip being formed from the group of materials consisting of cloth and rubber.

5. The device of claim 1, further comprising said first connector being positioned on said top face equally distant from said first end and said second end.

6. The device of claim 1, further comprising:
said strip being a first strip and a second strip, said first strip and said second strip each having a top surface and a bottom surface, said first strip and said second strip each having a proximate end, said first strip and said second strip each having a distal end, wherein said distal ends of said first strip and said second strip are configured to secure said first strip and said second strip to the watch,
a first fastener, said first fastener being positioned on said bottom surface proximate to said proximate end of said first strip; and
a second fastener, said second fastener being complimentary to said first fastener, said second fastener being positioned on said top surface proximate to said proximate end of said second strip, wherein said first fastener is configured to engage said second fastener, and with said first strip, said second strip and the watch forming a loop around the wrist of the watch wearer.

7. The device of claim 6, further comprising said first fastener and said second fastener connector being chosen from the group of materials consisting of Velcro type hook panel and Velcro type loop panel.

8. The device of claim 6, further comprising said distal ends of said first strip and said second strip being shaped as tubes, wherein said distal ends of said first strip and said second strip are configured to accept the pins of a watch to secure said first strip and said second strip to the watch.

9. The device of claim 6, further comprising said first strip and said second strip being formed from the group of materials consisting of cloth, rubber, metal and plastic.

10. The device of claim 6, further comprising said first strip and said second strip being formed from the group of materials consisting of cloth and rubber.

11. A replacement watch band device for watches, said device comprising:
a strip, said strip being flexible, said strip having a top face, a bottom face, a first end, and a second end,
a first coupler, said first coupler being positioned on said bottom face proximate to said first end,
a second coupler, said second coupler being complimentary to said first coupler, said second coupler being positioned on said top face proximate to said second end,
a first connector, said first connector being positioned on said top face equally distant from said first end and said second end; and
a second connector, said second connector being complimentary to said first connector, said second connector being positioned on the back side of the watch, said first coupler, said second coupler, said first connector and said second connector being chosen from the group of materials consisting of Velcro type hook panel and Velcro type loop panel, wherein said second connector is configured to engage said first connector to bond the watch to said strip, and said first coupler is configured to engage said second coupler with said strip forming a loop around the wrist of the watch wearer.

12. A replacement watch band device for watches, said device comprising:
a first strip and a second strip, said first strip and said second strip each having a top surface and a bottom surface, said first strip and said second strip each having a proximate end, said first strip and said second strip each having a distal end, said distal ends being shaped as tubes, wherein said distal ends of said first strip and said second strip are configured to accept the pins of a watch to secure said first strip and said second strip to the watch,
a first fastener, said first fastener being positioned on said bottom surface proximate to said proximate end of said first strip; and
a second fastener, said second fastener being complimentary to said first fastener, said second fastener being positioned on said top surface proximate to said proximate end of said second strip, said first fastener and said second fastener connector being chosen from the group of materials consisting of Velcro type hook panel and Velcro type loop panel, wherein said first fastener is configured to engage said second fastener with said first strip, said second strip, and the watch forming a loop around the wrist of the watch wearer.
